(19) United States
(12) Patent Application Publication
(10) Pub. No.: US 2025/0373667 A1
(43) Pub. Date: Dec. 4, 2025

(54) METHODS AND SYSTEMS FOR ENROLLING TARGET DEVICES WITH A SECURITY DEVICE MANAGEMENT SYSTEM

(71) Applicant: GENETEC INC., Saint-Laurent (CA)

(72) Inventors: Mathieu Fournier, Laval (CA); Philippe Maynard, Laval (CA); Jose Melancon, Saint-Laurent (CA); Jean-Francois Levesque, Laval (CA); Maxime Bedard, Montreal (CA)

(73) Assignee: GENETEC INC., Saint-Laurent (CA)

(21) Appl. No.: 19/254,750

(22) Filed: Jun. 30, 2025

Related U.S. Application Data
(63) Continuation of application No. 18/932,936, filed on Oct. 31, 2024.
(60) Provisional application No. 63/655,363, filed on Jun. 3, 2024.

(51) Int. Cl. H04L 9/40

(52) U.S. Cl. CPC H04L 63/20

(57) ABSTRACT

An example method for execution by a user computing apparatus communicatively coupled to a communication network to effect enrollment of a first target device with a security device management system comprises detecting that the first target device to be enrolled with the security device management system is connected to the communication network. In response to the detecting, the user computing apparatus may be caused to obtain a first enrollment token corresponding to the first target device. The first enrollment token may be usable by the user computing apparatus to enroll the first target device with the security management system. The first enrollment token may comprise data uniquely identifying the first target device. The user computing apparatus may be caused to cause transmission of the first enrollment token to a first remote system associated with the first target device to effect enrollment of the first target device with the security device management system.

### CROSS-REFERENCE TO RELATED APPLICATION

This application is a continuation of U.S. patent application Ser. No. 18/932,936 filed on Oct. 31, 2024, which claims the benefit of, and priority to, U.S. provisional patent application No. 63/655,363 filed on Jun. 3, 2024. The entire contents of U.S. patent application Ser. No. 18/932,936 and U.S. provisional patent application No. 63/655,363 are incorporated by reference herein.

### FIELD

The present disclosure relates generally to security systems including security device management systems and, in particular, to enrolling target devices with a security device management system.

### BACKGROUND

Once target devices of a security system are physically installed, the target devices may be enrolled with a security device management system. Enrolling target devices with a security device management system is typically a manual process completed by one or more human operators which involves individually configuring each of the target devices for enrollment with the security device management system. Such manual process may be extremely time consuming especially if a large number of target devices is to be enrolled with a security device management system. As such, improved methods and systems for enrolling target devices with a security device management system are desirable.

### SUMMARY

According to at least one embodiment, a method for execution by a user computing apparatus communicatively coupled to a communication network to effect enrollment of a first target device with a security device management system comprises: detecting that the first target device to be enrolled with the security device management system is connected to the communication network; in response to the detecting, causing the user computing apparatus to obtain a first enrollment token corresponding to the first target device, the first enrollment token usable by the user computing apparatus to enroll the first target device with the security device management system, the first enrollment token comprising data uniquely identifying the first target device; and causing transmission, by the user computing apparatus, of the first enrollment token to a first remote system associated with the first target device to effect enrollment of the first target device with the security device management system.

In some embodiments, causing transmission of the first enrollment token comprises causing the user computing apparatus to transmit the first enrollment token to the security device management system.

In some embodiments, causing the user computing apparatus to obtain the first enrollment token comprises the user computing apparatus receiving the first enrollment token from the first target device.

In some embodiments, the user computing apparatus receiving the first enrollment token comprises establishing a secure connection between the first target device and the user computing apparatus for the first target device to transmit the first enrollment token to the user computing apparatus.

In some embodiments, causing the user computing apparatus to obtain the first enrollment token comprises the user computing apparatus receiving the first enrollment token from the first remote system.

In some embodiments, the user computing apparatus receiving the first enrollment token comprises establishing a secure connection between the first remote system and the user computing apparatus for the first remote system to transmit the first enrollment token to the user computing apparatus.

In some embodiments, the method further comprises in response to obtaining the first enrollment token, causing the user computing apparatus to verify the first enrollment token.

In some embodiments, causing the user computing apparatus to verify the first enrollment token comprises at least partially comparing the data of the first enrollment token against expected data of the first enrollment token.

In some embodiments, the first enrollment token comprises a signature and causing the user computing apparatus to verify the first enrollment token comprises causing the user computing apparatus to authenticate the signature of the first enrollment token.

In some embodiments, detecting that the first target device to be enrolled with the security device management system is connected to the communication network comprises causing the user computing apparatus to perform network discovery detecting one or more devices connected to the communication network.

In some embodiments, the network discovery is performed periodically.

In some embodiments, the network discovery is initiated by a user of the user computing apparatus.

In some embodiments, the network discovery is initiated by the first target device being communicatively coupled to the communication network.

In some embodiments, the network discovery comprises causing the user computing apparatus to compare a newly detected network device identifier against one or more known network device identifiers associated with one or more devices already enrolled with the security device management system.

In some embodiments, the network discovery comprises causing the user computing apparatus to detect one or more devices comprising at least one flag set to indicate the corresponding device is newly connected to the communication network.

In some embodiments, the method further comprises in response to the detecting, causing the user computing apparatus to verify that the first target device is to be enrolled with the security device management system prior to obtaining the first enrollment token.

In some embodiments, the method further comprises in response to obtaining the first enrollment token corresponding to the first target device, causing the user computing apparatus to obtain a second enrollment token corresponding to a second target device to be enrolled with the security device management system and to cause transmission of the second enrollment token to a second remote system associated with the second target device to effect enrollment of the second target device.

In some embodiments, the method further comprises in response to obtaining the second enrollment token, causing the user computing apparatus to verify the second enrollment token.

In some embodiments, the first remote system and the second remote system are the same.

In some embodiments, the method further comprises upon effecting enrollment of the second target device with the security device management system, causing the user computing apparatus to determine whether a third target device is to be enrolled with the security device management system.

In some embodiments, the first target device is a surveillance image capture device, an intercom device or an access control device.

In some embodiments, the first target device is initially communicatively coupled to the first remote system by the communication network.

In some embodiments, causing the user computing apparatus to obtain the first enrollment token corresponding to the first target device comprises causing the user computing apparatus to transmit a unique identifier of the first target device in exchange for the first enrollment token.

According to at least one embodiment, a method for execution by a user computing apparatus communicatively coupled to a communication network to effect enrollment of a plurality of target devices with a security device management system comprises: detecting that the plurality of target devices are connected to the communication network; causing the user computing apparatus to obtain a plurality of enrollment tokens, each of the enrollment tokens corresponding to a corresponding target device of the plurality of the target devices, each of the enrollment tokens usable by the user computing apparatus to enroll the corresponding target device with the security device management system, each of the enrollment tokens comprising data uniquely identifying the corresponding target device; and causing transmission, by the user computing apparatus, of each enrollment token of the plurality of enrollment tokens to a remote system associated with the corresponding target device to effect enrollment of the corresponding target device with the security device management system.

In some embodiments, causing the user computing apparatus to obtain a plurality of enrollment tokens comprises causing the user computing apparatus to generate the plurality of enrollment tokens.

In some embodiments, each of the plurality of enrollment tokens is generated from data received by the user computing apparatus from the remote system associated with the corresponding target device.

In some embodiments, each target device of the plurality of target devices is a surveillance image capture device, an intercom device or an access control device.

In some embodiments, detecting that the plurality of target devices are connected to the communication network is performed subsequent to the causing transmission of each of the enrollment tokens.

According to at least one embodiment, a method for execution by a user computing apparatus communicatively coupled to a communication network to effect enrollment of a target device with a security device management system comprises: causing the user computing apparatus to obtain an enrollment token corresponding to the target device, the enrollment token usable by the user computing apparatus to enroll the target device with the security device management system, the enrollment token comprising data uniquely identifying the target device; and causing transmission, by the user computing apparatus, of the enrollment token to a remote system associated with the target device to effect enrollment of the target device with the security device management system.

In some embodiments, the method further comprises subsequent to the causing transmission of the enrollment token detecting that the target device is connected to the communication network.

According to at least one embodiment, a surveillance image capture device comprises a processor configured to: communicatively couple the surveillance image capture device to a remote system associated with the surveillance image capture device; and upon receiving at least one identifier of a security device management system from the remote system in response to the remote system receiving an enrollment token of the target device, uncouple the surveillance image capture device from the remote system and enroll the surveillance image capture device with the security device management system.

According to at least one embodiment, a surveillance image capture device comprises a processor configured to cause transmission of an enrollment token to a user computing apparatus communicatively coupled to a security device management system, the enrollment token comprising data uniquely identifying the surveillance image capture device.

In some embodiments, the processor is configured to cause transmission of the enrollment token to the user computing apparatus upon receiving a request for the enrollment token from the user computing apparatus.

According to at least one embodiment, a remote system associated with a target device comprises a processor configured to: communicatively couple the target device to the remote system; receive an enrollment token of the target device, the enrollment token comprising data uniquely identifying the target device; and in response to receiving the enrollment token, effect enrollment of the target device with a security device management system.

According to at least one embodiment, a computer program product comprises a computer readable memory storing computer executable instructions thereon that when executed by a computer perform any method described herein.

Other aspects and features will become apparent to those ordinarily skilled in the art upon review of the following description of illustrative embodiments in conjunction with the accompanying figures.

### BRIEF DESCRIPTION OF THE DRAWINGS

While the invention is claimed in the concluding portions hereof, example embodiments are provided in the accompanying detailed description which may be best understood in conjunction with the accompanying figures where like parts in each of the several figures are labeled with like numerals, and where:

FIG. 1 is a schematic illustration of a security system according to one embodiment;

FIG. 2 is a schematic illustration of a user computing apparatus according to one embodiment;

FIG. 3 is a block diagram showing program codes for enrolling a target device with a security device management system according to one embodiment;

FIG. 4 is a schematic illustration of an enrollment token according to one embodiment;

FIG. 5 is a block diagram showing program codes for obtaining an enrollment token according to one embodiment;

FIG. 6 is a schematic illustration of enrollment token generation data according to one embodiment;

FIG. 7 is a block diagram showing program codes for enrolling a target device with a security device management system according to one embodiment;

FIG. 8 is a block diagram showing program codes for enrolling a target device with a security device management system according to one embodiment;

FIG. 9 is a block diagram showing program codes for enrolling a target device with a security device management system according to one embodiment;

FIG. 10 is a schematic illustration of a surveillance image camera according to one embodiment; and

FIG. 11 is a schematic illustration of a remote system associated with a target device according to one embodiment.

### DETAILED DESCRIPTION

The following discussion provides many example embodiments of the inventive subject matter. Although each embodiment represents a single combination of inventive elements, the inventive subject matter is considered to include all possible combinations of the disclosed elements.

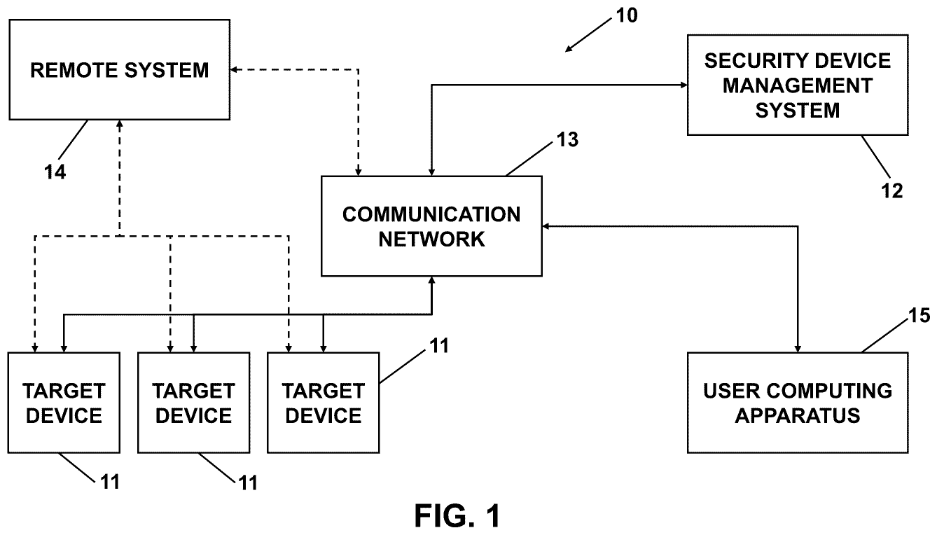

With reference to FIG. 1, there is shown a security system 10 according to one example embodiment. The security system 10 comprises target devices 11. Typically, the security system 10 comprises a plurality of target devices 11. However, in some embodiments, the security system 10 comprises a single target device 11. The target devices 11 are configured to maintain or monitor security of a desired area by collecting surveillance data from the area and/or controlling access to the area. For example, the one or more target devices 11 may include image capture devices configured to capture still or video images (e.g., cameras), access control devices (e.g., access card readers, access control pin pads, electronically controlled locking devices, etc.), audio capture devices (e.g., microphones), intercom devices (e.g., devices operable to facilitate one or two-way communication), alarm panels, combinations of two or more thereof, etc. Different ones of the target devices 11 may be the same or different. Suitable target devices 11 may be based on a variety of commercially available models made by a variety of manufacturers.

The system 10 also comprises a security device management system 12 configured to receive and manage data from the target devices 11. A user may monitor data from the target devices 11 (e.g., monitor still image or video feeds from cameras, monitor access card scans, etc.) using the security device management system 12. In some embodiments, the security device management system 12 includes, or is, a video management system. The security device management system 12 (or a video management system) may be based on an existing system such as Genetec™ Security Center. In some embodiments, the security device management system 12 is a cloud-based system.

The target devices 11 securely communicate with the security device management system 12 over a communication network 13. The communication network 13 may include routers, switches, splitters, buffers and any other components needed to communicate between the target devices 11 and the security device management system 12. In some embodiments, the communication network 13 is at least partially a cloud network. In some embodiments, the communication network is a local network.

A target device 11 typically cannot immediately securely communicate with the security device management system 12. A brand-new target device 11 (e.g., a target device that is still in its original packaging such as a box or wrapped in plastic) or a target device 11 that has been reset needs to be enrolled with the security device management system 12 for the target device 11 to be able to securely communicate with the security device management system 12. In some embodiments, such a target device 11 is first installed (or initialized). Once installed, the target device 11 may be enrolled with the security device management system 12.

Installing a target device 11 includes connecting the target device 11 to the communication network 13. The target device 11 may be physically connected to the communication network 13 (e.g., with a cable) or may be wirelessly connected to the communication network 13. Additionally, installing a target device 11 may include configuring the target device 11 with an initial set of operating settings. Initializing the target device 11 may, for example, include connecting the target device 11 to a remote system 14 associated with the target device 11 such as a server operated by the manufacturer of the target device 11 (either through the communication network 13 or another communication network such as a public network connected to the Internet) and using a manufacturer application programming interface (API) to configure the target device 11. In some embodiments, configuring the target device 11 includes creating an account for the target device 11 which includes credentials such as a user name and password. Different target devices 11 may be associated with the same remote system 14 (e.g., if they are produced by the same manufacturer) or different remote systems 14 (e.g., if they are produced by different manufacturers). Although the present disclosure primarily describes the remote system 14 as being operated by a manufacturer of the target device 11, it should be understood that in some cases, the remote system 14 may be operated by another entity. For example, the remote system 14 may be operated by a third party trusted or otherwise designated by the manufacturer to perform various operations in relation to the target device 11, as described herein. In one non-limiting embodiment, the remote system 14 is operated by the same entity which provides, provisions, and/or operates the security device management system 12.

In some embodiments, the target device 11 is connected to the remote system 14 and initialized prior to being connected to the communication network 13. For example, the target device 11 may include a communications interface, such as cellular modem, which allows it to connect to the remote system 14 independently from the communication network 13; the target device 11 may then be connected to the communication network 13 by the same communications interface, or by a different interface (e.g., a wired Ethernet port, a Wi-Fi antenna, etc.), as appropriate. In some embodiments, the target device 11 is connected to the remote system 14 and initialized substantially simultaneously with being connected to the communication network 13. For example, initialization of the target device 11 may require, or include, connecting the target device to the communication network 13 and/or the remote system 14, whether via the same communications interface or via different communications interfaces. In some embodiments, the target device 11 is connected to the remote system 14 and initialized after being connected to the communication network 13. For example, the target device 11 may only be able to communicate with the remote system 14 through the communication network 13, whether due to limitations in the number or type of communications interfaces of the target device, or as a result of the location where the target device 11 is deployed. In some embodiments, the target device 11 is connected to the remote system 14 in response to a request for the target device 11 to provide an enrollment token as described elsewhere herein or a request for provision of other data or information which requires a connection to the remote system 14. In other embodiments, other events, such as interaction with the target device 11 by a user, by another device on the communication network 13, or the like, can cause the target device 11 to be initialized, to be connected to the remote system 14, and/or to be connected to the communication network 13, in any suitable fashion.

In some embodiments, a target device 11 is connected to the remote system 14 with a first network which is different from the communication network 13. The first network may have internet access (the communication network 13 may not have internet access). The first network may be a local network. Initial enrollment of the target device 11 (such as initialization of the target device 11, for example) may be performed using the first network. The target device 11 may then be enrolled with the security device management system and be connected to the communication network 13.

Once a target device 11 is installed (e.g., communicatively coupled to the communication network 13 and, in some cases, configured as ready to be used), the target device 11 may be enrolled with the security device management system 12 so that the target device 11 can securely communicate with the security device management system 12.

In embodiments described herein, enrolling a target device 11 (or effecting enrollment of a target device 11) comprises obtaining an enrollment token (also may be known as a “transfer token”) corresponding to the target device 11. The enrollment token represents or proves ownership of the target device 11. Transmitting the enrollment token to a remote system 14 associated with the target device 11 may cause the remote system 14 to configure the target device 11 to securely communicate with a desired security device management system 12 and thereby enroll the target device 11 with the security device management system 12.

A user computing apparatus 15 may, for example, be caused to enroll the target device 11 (or effect enrollment of the target device 11) with the security device management system 12.

The user computing apparatus 15 is a computing device and may, in various embodiments, include a user computing device, a server computing device, a personal computer, a laptop computer, a tablet computer, a smartphone, a mobile device, or one or more other devices including one or more other computing devices, or a combination of two or more thereof.

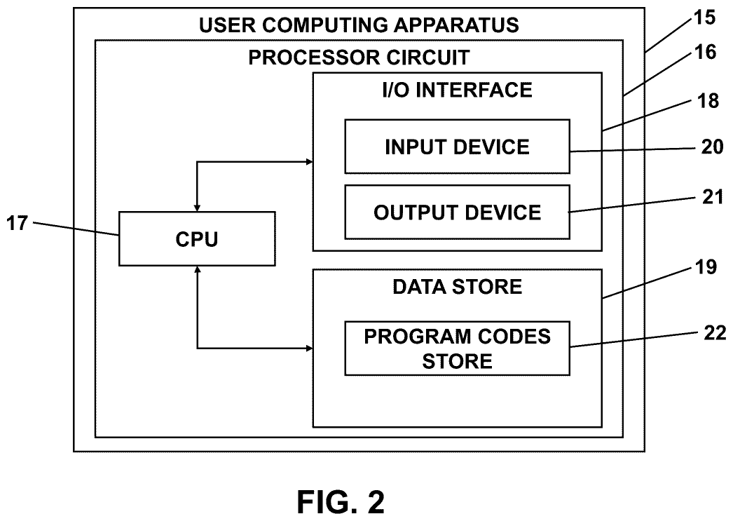

With reference to FIG. 2, the user computing apparatus 15 includes a processor circuit 16. The processor circuit 16 includes a central processing unit (CPU) 17. However, alternative embodiments may include one or more alternatives to the CPU 17, such as one or more microprocessors, one or more analog circuits, one or more configurable logic blocks, one or more application-specific integrated circuits (ASICs), or one or more field programmable gate arrays (FPGAs), for example. The processor circuit 16 also includes an input/output (I/O) interface 18 and a data-storage device 19 in communication with the CPU 17.

The I/O interface 18 may include various signal interfaces, analog-to-digital converters (ADCs), receivers, transmitters, and/or other circuitry to receive, produce, and transmit signals as described herein, for example. In general, signals as described herein may include one or more radio signals, one or more optical signals, one or more electronic signals, or a combination of two or more thereof. In the embodiment shown, the I/O interface 18 is operable to transmit signals to, and receive signals from, the computer network 13 using one or more networks such as the Internet, one or more wired networks, one or more wireless networks, or a combination of two or more thereof, for example.

The I/O interface 18 may be operable to receive signals from one or more input devices, such as an input device 20 that may include a keyboard, a mouse, a touchscreen, a microphone, another user-input device, another input device, or a combination of two or more thereof to receive inputs, such as user inputs from a user of the user computing apparatus 15 for example. Also, the I/O interface 18 may be operable to transmit signals to one or more output devices such as an output device 21 that may include a display screen, an audio speaker, a projector, another user-output device, another output device, or a combination of two or more thereof to control one or more such output devices to produce output, for example for the user of the user computing apparatus 15. The input device 20 and the output device 21 are shown as separate devices, but may be collectively one device such as a touchscreen, for example. Also, the input device 20 and the output device 21 are shown in FIG. 2 as part of the user computing apparatus 15, but in alternative embodiments one or more input devices, one or more output devices, or both may be separate from the user computing apparatus 15.

The data-storage device 19 may include one or more of the same or different computer-readable and/or computer-writable data-storage media, which in various embodiments may include one or more of a read-only memory (ROM), a random access memory (RAM), a hard disc drive (HDD), a solid-state drive (SSD), and other computer-readable and/or computer-writable data-storage media.

The data-storage device 19 includes a program-codes store 22 storing program codes that, when executed by the CPU 17, cause the processor circuit 16 to implement functions of the user computing apparatus 15 such as those described herein, for example.

The processor circuit 16 is an example only, and alternative embodiments may differ. For example, alternative embodiments may include more, fewer, or different components. Also, in alternative embodiments, components described herein may be combined or separated into separate components. Alternative embodiments may include one or more alternatives to components as described herein. Further, an alternative to the user computing apparatus 15 may include multiple devices that collectively function as the user computing apparatus 15.

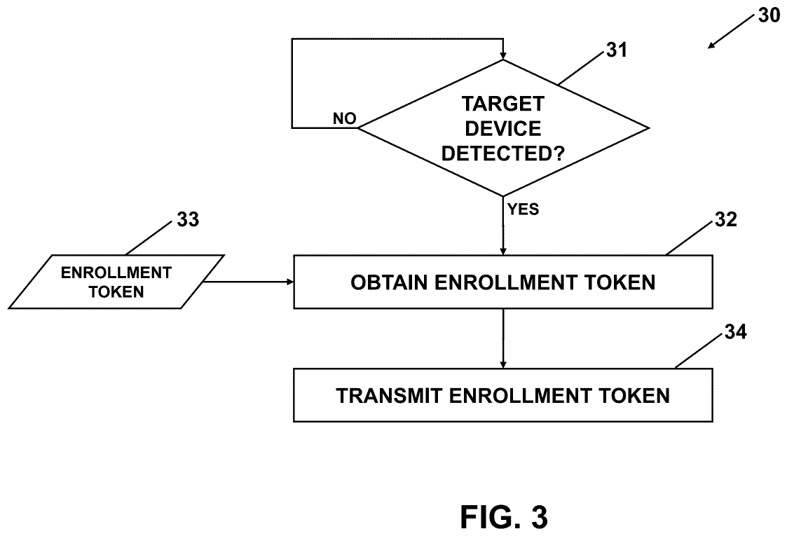

Referring to FIG. 3, program codes stored in the program-codes store 22 may include blocks of program codes shown generally at 30 that, when executed by the CPU 17, cause the processor circuit 16 to enroll a target device 11 (or effect enrollment of a target device 11) with a security device management system 12 such that the target device 11 may securely communicate with the security device management system 12. It should be understood that, as used throughout the present disclosure, the term “blocks” or “block”, as well as the visual representation thereof, are employed to facilitate understanding, and should not be taken as a limitation of the particular format or structure of the program codes themselves.

The blocks 30 may begin at a block 31 including program codes that, when executed by the CPU 17, cause the processor circuit 16 to detect whether a target device 11 that is not yet enrolled with the security device management system 12 is connected to the communication network 13 (i.e., an “unenrolled” target device). To detect an unenrolled target device, the processor circuit 16 may be caused to perform network discovery. In some embodiments, the network discovery is performed periodically. In some embodiments, a user of the user computing apparatus 15 initiates the network discovery (e.g., through I/O interface 18). In some embodiments, the network discovery is initiated by a target device 11 being coupled to the communication network 13. Other triggers for performing the network discovery may also be considered. In some embodiments, a target device 11 announces itself upon being coupled to the communication network 13. The processor circuit 16 may be caused to identify the announced target device 11 thereby detecting the announced unenrolled target device. In some embodiments, the processor circuit 16 receives user input identifying an unenrolled target device.

Data such as a MAC (media access control) address, an IP (internet protocol) address, device serial number, etc. may identify a target device 11. The network discovery may include comparing identifying data of a detected target device 11 against identifying data of already enrolled target devices 11. The processor circuit 16 may store data which identifies target devices 11 which have already been enrolled with the security device management system 12 (i.e., the “enrolled” target devices) in, for example, the data-storage device 19. Data identifying a target device 11 detected on the communication network 13 may be compared against the stored data identifying the enrolled target devices to determine whether the detected target device 11 is an unenrolled target device. For example, a MAC address of a detected target device 11 may be compared against the stored MAC addresses of the enrolled target devices to determine whether the detected target device 11 is an unenrolled target device.

Additionally, or alternatively, a target device 11 may set at least one flag based on whether the target device 11 is an unenrolled target device or an enrolled target device. The processor circuit 16 may determine whether a target device 11 is an unenrolled target device or an enrolled target device at least partially based on the status of the at least one flag. Upon being connected to the communication network 13, a target device 11 may, for example, set at least one flag identifying the target device 11 as a target device which is newly connected to the communication network 13 to its “active” or “enabled” state. The processor circuit 16 may be caused to scan the communication network 13 and/or to interrogate various devices on the communication network 13 and detect a target device 11 with the at least one flag set to its “active” or “enabled” state to detect an unenrolled target device. If a target device 11 does not have the flag set to its “active” or “enabled” state, the processor circuit 16 may, for example, disregard the target device 11. In some embodiments, the processor circuit 16 accesses the at least one flag through an API of the target device 11.

If an unenrolled target device is not detected, the blocks 30 may remain at block 31 causing the processor circuit 16 to continue to detect an unenrolled target device.

If an unenrolled target device is detected, the blocks 30 may continue at block 32 including program codes that, when executed by the CPU 17, cause the processor circuit 16 to obtain an enrollment token 33 corresponding to the detected unenrolled target device.

The enrollment token 33 is a digital token (or certificate) uniquely associated to the corresponding target device 11. Possession of the enrollment token 33 establishes (or proves) ownership of the corresponding target device 11. As described elsewhere herein, the target device 11 may initially be communicatively coupled to the remote system 14 associated with the target device 11. In order to enroll the target device 11 with the security device management system 12, the target device 11 may need to be configured for enrollment with the security device management system 12 by the remote system 14. The remote system 14 may be caused to configure the target device 11 for enrollment with the security device management system 12 upon the remote system 14 receiving an enrollment token 33 corresponding to the target device 11 (e.g., the transmitter of the enrollment token 33 has sufficiently proven to the remote system 14 that they are the owner of the target device 11 by providing the enrollment token 33 corresponding to the target device 11). A plurality of enrollment tokens 33 may be uniquely associated with a target device 11 over the lifespan of the target device 11.

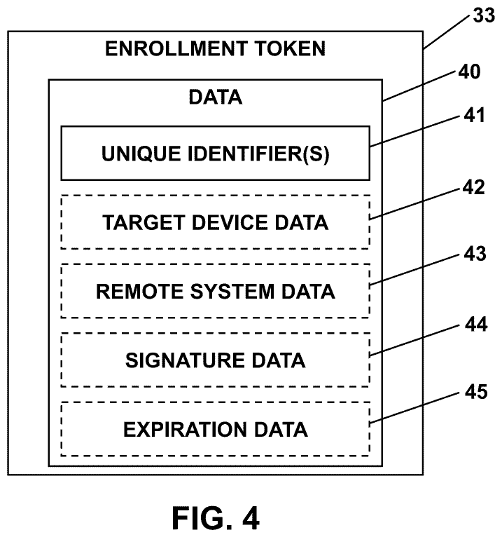

Referring to FIG. 4, an example enrollment token 33 is schematically shown. Enrollment token 33 includes data 40 which includes at least one unique identifier 41 of the target device 11 to which the enrollment token 33 corresponds to. For example, the at least one unique identifier 41 may be a serial number of the target device 11, a password of the target device 11, a unique key of the target device 11, account credentials of the target device 11, etc. By way of another example, the unique identifier 41 may be an encrypted nonce value or other secret known to the target device 11 and to the remote system 14, for instance stored in the target device by the manufacturer thereof during the manufacturing process and then provided to the remote system 14. The unique identifier 41 may, for instance, be encrypted with a private key of a private-public key pair associated with the target device. The remote system 14 may have access to the public key of the private-public key pair, and be able to decrypt the unique identifier 41 to validate the nonce value or other secret which was known originally to only the target device 11 and to the remote system 14. Other approaches may also be considered.

The data 40 may also include target device data 42 which represents one or more characteristics of the target device 11 such as type of device, model number, manufacturer of the target device, operating characteristics, etc. Additionally, or alternatively, the data 40 may include remote system data 43 which represents one or more characteristics of the remote system 14 associated with the target device 11 such as type of remote system, network address of the remote system, a public key associated with the remote system 14, etc.

An enrollment token may be digitally (or electronically) signed or endorsed by a provider of the enrollment token 33. Data corresponding to the signature may be stored as signature data 44 in data 40 of the enrollment token 33. An enrollment token 33 may be verified or authenticated by verifying or authenticating the signature data 44. In some embodiments, the signature data 44 is verified or authenticated using a public key of the provider of the enrollment token 33, which, in some instances, is the same entity responsible for managing the remote system 14, or an entity associated therewith in any suitable fashion.

In some embodiments, the enrollment token 33 is time-limited (i.e., the enrollment token 33 expires after the duration of a pre-set amount of time). For example, the enrollment token 33 may expire after 5 minutes, 10 minutes, 2 hours, 6 hours, 1 day, 1 week, 1 month, 3 months, 1 year, etc. Data representing a time-limit of the enrollment token 33 may be stored as expiration data 45 in data 40 of the enrollment token 33.

The processor circuit 16 may obtain the enrollment token 33 by requesting the enrollment token 33 from a provider of the enrollment token 33. In some embodiments, the provider of the enrollment token 33 is the target device 11 which has an enrollment token 33 stored in data or is configured to generate (or retrieve) an enrollment token 33. For example, a user of the user computing apparatus 15 may employ the processor circuit 16 to obtain the enrollment token of the target device 11 by connecting to the target device 11 and interacting with a configuration page hosted by the target device. In some embodiments, the provider of the enrollment token 33 is the remote system 14 associated with the target device 11 which has an enrollment token 33 corresponding to the target device 11 stored in data or is configured to generate (or retrieve) an enrollment token 33 corresponding to the target device 11. In some other embodiments, the provider of the enrollment token 33 may be some other source or system, for instance an authentication or credentials server operated by the same entity which operates the remote server 14, or operated by a third party authorized by the manufacturer of the target device or the entity managing the remote system 14. Other entities may also serve as a provider for the enrollment token, as appropriate, provided they are sufficiently authorized to serve as a provider by an authority for the target device 11, for instance by the manufacturer of the target device 11.

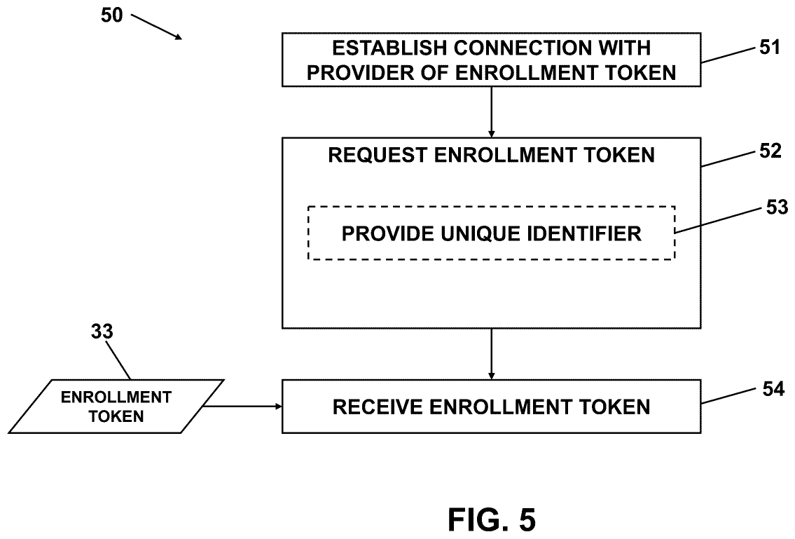

Referring to FIG. 5, program codes stored in the program-codes store 22 may include blocks of program codes shown generally at 50 that, when executed by the CPU 17, cause the processor circuit 16 to obtain an enrollment token 33 of the target device 11.

The blocks 50 may begin at a block 51 including program codes that, when executed by the CPU 17, cause the processor circuit 16 to establish a network connection with a provider of the enrollment token 33. The network connection with the provider of the enrollment token 33 may be a secure network connection. The processor circuit 16 may establish a network connection with the provider of the enrollment token 33 through the communication network 13, through a separate network connection, or through a combination of networks including the communication network 13. For example, the processor circuit 16 may establish a network connection with the target device 11 over the communication network 13, following initialization and connection of the target device to the communication network. By way of another example, the processor circuit 16 may establish a network connection with the remote system 14, which is separate from the communication network 13, via the Internet (at least in part). In the event that another device acts as the provider of the enrollment token 33, the processor circuit 16 may connect to the other device in any suitable fashion.

Upon establishing a network connection with the provider of the enrollment token 33, the blocks 50 may continue at block 52 including program codes that, when executed by the CPU 17, cause the processor circuit 16 to request the enrollment token 33 from the provider of the enrollment token 33. In some embodiments, requesting the enrollment token 33 from the provider of the enrollment token 33 includes causing the processor circuit 16 to provide a unique identifier of the target device 11 such as a serial number of the target device or log-in credentials of an account associated with the target device 11 to the provider of the enrollment token 33 (e.g., block 53). The enrollment token 33 may, for example, be requested through an API of the target device 11 or of the remote system 14.

Once the enrollment token 33 is requested, the blocks 50 may continue at block 54 including program codes that, when executed by the CPU 17 cause the processor circuit 16 to receive the enrollment token 33 from the provider of the enrollment token 33. The provider of the enrollment token 33 (e.g., the target device 11, the remote system 14 associated with the target device 11, etc.) may transmit the enrollment token 33 using the network connection established with the processor circuit 16 (or user computing apparatus 15 generally). In some embodiments, the processor circuit 16 stores (at least temporarily) the received enrollment token 33 in data-storage device 19.

In some embodiments, the enrollment token may be requested in an ad hoc process by communicating with an entity responsible for managing the target device 11 and/or the remote system 14. For example, the processor circuit 16 may be employed to issue a request for the unique identifier associated with the target device 11 to the entity responsible for managing the target device 11. The processor circuit 16 may then be employed to store the unique identifier of the target device 11 and to submit it via a webpage or the like hosted by the remote system 14, in order to request the enrollment token 33. The remote system 14 may then return the enrollment token 33 to the user computing apparatus 15 for use thereby in effecting enrollment of the target device 11.

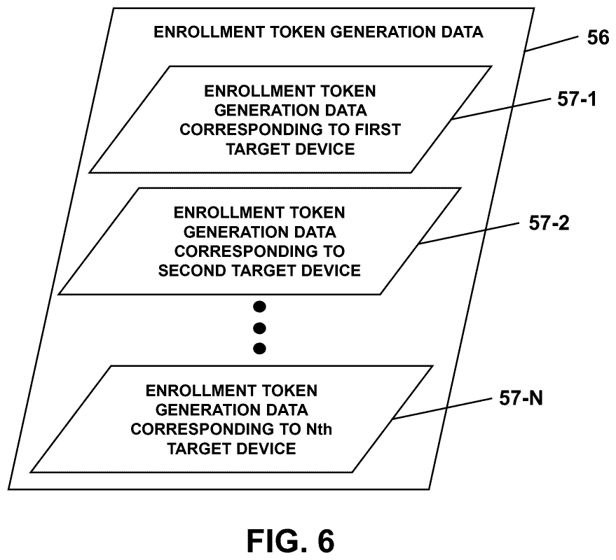

In some embodiments, causing the processor circuit 16 to obtain an enrollment token 33 corresponding to the target device 11 comprises causing the processor circuit 16 to generate the enrollment token 33. The enrollment token 33 may be at least in part generated from data received by the processor circuit 16. For example, a plurality of target devices 11 may be ordered from a manufacturer. The manufacturer of the target devices 11 may provide enrollment token generation data from which an enrollment token corresponding to each of the target devices 11 in the plurality of target devices 11 may be generated from. Additionally, the enrollment token generation data may include data from which a signature may be generated for each of the enrollment tokens. The enrollment token generation data may be provided, for example, at the time the target devices 11 are ordered, shipped, received, or the like. Referring to FIG. 6, example enrollment token generation data shown generally at 56 is illustrated. In the illustrated embodiment, the enrollment token generation data 56 includes a plurality of data entries 57 where from each of the data entries 57 an enrollment token 33 corresponding to a target device 11 may be generated.

In some embodiments, enrollment token generation data 56 is included in, or at least partially extracted (e.g., by the processor circuit 16 as described elsewhere herein) from, information or document(s) corresponding to a target device such as an invoice, purchase order, a bill of materials, a listing received from at least one entity associated with a remote system associated with the corresponding target device, a listing received from at least one entity associated with the security device management system, etc. For example, a bill of materials obtained from the manufacturer of the target devices 11 may include a listing of the respective serial numbers of each of the target devices 11. The serial numbers may serve as the unique identifiers 41 used to construct the enrollment tokens 33, or to request the enrollment tokens 33 (or enrollment token generation data 56) from a suitable entity, as described elsewhere herein.

In some embodiments, causing the processor circuit 16 to obtain an enrollment token 33 corresponding to the target device 11 comprises causing the processor circuit 16 to retrieve the enrollment token 33 from a data store (such as data store 19, for example).

In some embodiments, the processor circuit 16 is caused to generate or obtain an enrollment token 33 corresponding to a target device 11 prior to the processor circuit 16 detecting the unenrolled target device (e.g., prior to the processor circuit 16 detecting that the target device 11 is connected to the communication network 13). The generated enrollment token may be transmitted to the remote system 14 associated with the target device 11 prior to the target device 11 being communicatively coupled to the communication network 13. Once the target device 11 is communicatively coupled to the communication network 13, the target device 11 may, for example, be enrolled with the security device management system 12. As described elsewhere herein, a plurality of enrollment tokens 33 corresponding to a plurality of target devices 11 may be generated substantially concomitantly, or at disparate times, and at any suitable time after the information needed to generate the enrollment tokens 33 (e.g., the unique identifier(s) 41) are obtained. The plurality of enrollment tokens 33 may be generated prior to the plurality of target devices 11 being communicatively coupled to the communicative network 13. The plurality of enrollment tokens 33 may also be transmitted—as described hereinbelow—to the remote system 14 at any suitable time, including prior to the plurality of target devices 11 being communicatively coupled to the communicative network 13.

Returning to FIG. 3, once an enrollment token 33 is obtained, the blocks 30 may continue at block 34 including program codes that, when executed by the CPU 17 cause the processor circuit 16 to cause transmission of the enrollment token 33 to the remote system 14 associated with the target device 11 to effect enrollment of the target device with the security device management system 12. In some embodiments, the processor circuit 16 transmits the enrollment token to the security device management system 12, and the enrollment token 33 is then transmitted from the security device management system 12 to the remote system 14 associated with the target device 11.

Once the remote system 14 associated with the target device 11 receives the enrollment token 33, the remote system 14 may proceed to cause enrollment of the target device 11 with the security device management system 12. The remote system 14 may receive data identifying the security device management system 12 together with the enrollment token 33. In some embodiments, the remote system 14 provides configuration settings of the security device management system 12 to the target device 11 for the target device 11 to be enrolled with and securely connected to the security device management system 12. As part of enrolling the target device 11, the remote system 14 may uncouple the target device 11 from the remote system 14 (e.g., disconnect any communication network between the remote system 14 and the target device 11).

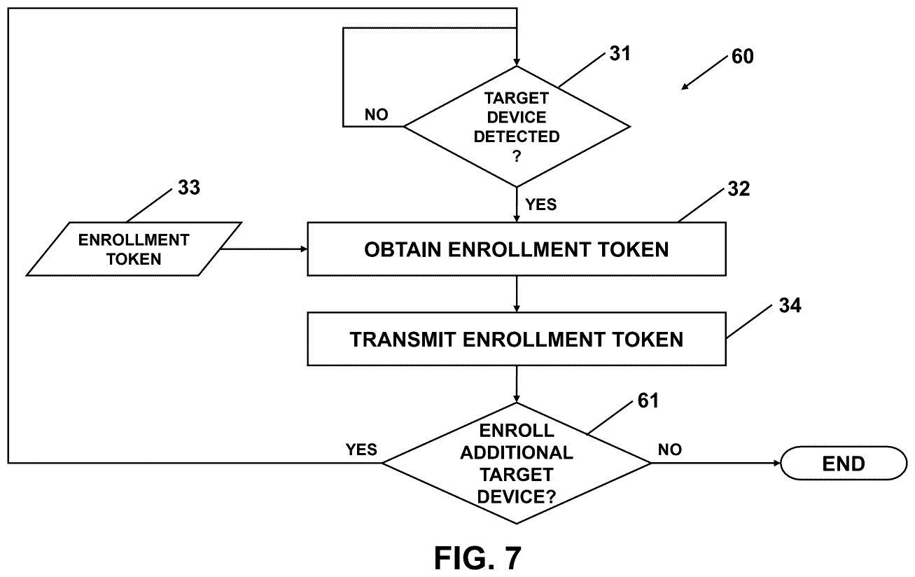

In some embodiments, a plurality of target devices 11 may need to be enrolled with the security device management system 12. In some embodiments, a large number (e.g., more than 10 target devices 11, more than 20 target devices 11, more than 50 target devices 11, more than 100 target devices 11, more than 1000 target devices 11, etc.) may need to be enrolled with the security device management system 12 at one time (e.g., over a span of a few minutes, a few hours, a few days, a few weeks, etc.). With reference to FIG. 7, program codes stored in the program-codes store 22 may include blocks of program codes shown generally at 60 that, when executed by the CPU 17, cause the processor circuit 16 to enroll a plurality of target device 11 with the security device management system 12 such that the plurality of target devices 11 may securely communicate with the security device management system 12.

The blocks 60 are the same as the blocks 30 except that the blocks 60 also include block 61 after block 34. Block 61 includes program codes that, when executed by the CPU 17 cause the processor circuit 16 to determine whether there is an additional target device 11 to be enrolled with the security device management system 12. For example, the processor circuit 16 may know that a total of N target devices 11 are to be enrolled with the security device management system 12. The processor circuit 16 may keep a counter of the number of target devices 11 enrolled with the security device management system 12 thus far. If the counter value is less than N, the processor circuit 16 may determine that at least one additional target device 11 is to be enrolled with the security device management system 12. As another example, the processor circuit 16 may implement a count-down counter which counts down from the total number N of target devices 11 after each target device 11 is enrolled with the security device management system 12. As another example, the number of target devices 11 to be enrolled with the security device management system 12 may be dynamically updated based on the number of unenrolled target devices connected to the communication network 13.

If at block 61 it is determined that another target device 11 is to be enrolled with the security device management system 12, the blocks 60 may return to block 31. If at block 61 it is determined that another target device 11 is not to be enrolled with the security device management system 12 (e.g., all of the target devices 11 are enrolled with the security device management system 12), the blocks 60 may end.

In some embodiments, the processor circuit 16 may be caused to verify whether a detected unenrolled target device is to be enrolled with the security device management system 12 prior to causing the processor circuit 16 to obtain an enrollment token 33 corresponding to the unenrolled target device. Verifying whether a detected unenrolled target device is to be enrolled with the security device management system 12 may advantageously save computational resources by avoiding a case where an enrollment token 33 is obtained for a device that is not to be enrolled with the security device management system 12.

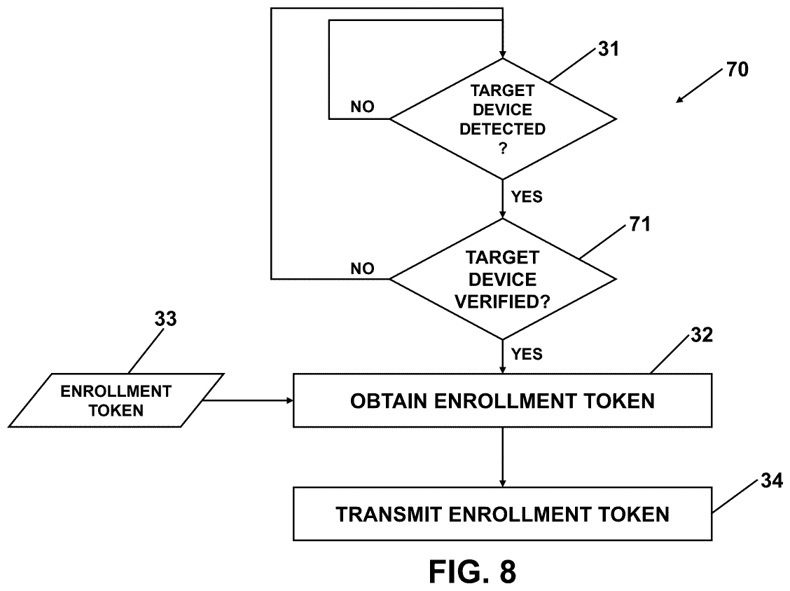

Referring to FIG. 8, program codes stored in the program-codes store 22 may include blocks of program codes shown generally at 70 that, when executed by the CPU 17, cause the processor circuit 16 to verify whether a detected unenrolled target device is to be enrolled with the security device management system 12 as part of enrolling the unenrolled target device with the security device management system 12. The blocks 70 are the same as the blocks 30 except that the blocks 70 also include block 71 between blocks 31 and 32. If at block 71 the detected unenrolled device is verified, the blocks 70 may continue at block 32. If, however, at block 71 the detected unenrolled device is not verified, the blocks 70 may return to block 31.

Whether a detected unenrolled target device is to be enrolled with the security device management system 12 may be verified, for example, by comparing data representing the detected unenrolled target device (e.g. MAC address, IP address, etc.) against data representing target devices 11 to be enrolled with the security device management system 12. If, for example, the MAC address of the detected unenrolled target device matches a MAC address in the data representing target devices 11 to be enrolled with the security device management system 12, then the detected unenrolled target device may be verified as a target device to be enrolled with the security device management system 12. In contrast, if, for example, the MAC address of the detected unenrolled target device does not match a MAC address in the data representing target devices 11 to be enrolled with the security device management system 12, then the detected unenrolled target device may not be verified as a target device to be enrolled with the security device management system 12 and the detected unenrolled target device would not be enrolled with the security device management system 12.

In some embodiments, determining whether an unenrolled target device is to be enrolled with the security device management system 12 may require an exchange of information with the unenrolled target device. Although certain types of data representing the target devices 11 (e.g., the aforementioned MAC address or IP address) may be obtained from network discovery, in some cases, other information may be required to determine whether an unenrolled target device is to be enrolled with the security device management system 12. For instance, a serial number, associated account name, or the like, may be required; this information may be obtained by querying the target devices 11, for instance via an API, or using any other suitable communication protocols. In some cases, the querying of the target devices 11 may be performed substantially automatically as part of a network discovery process or the like: for instance, during network discovery, every discovered target device 11 is then queried to obtain its serial number via an API. Other approaches may also be considered.

One or more transmission errors, malicious acts, etc. may cause an enrollment token 33 to be nonviable. In some embodiments, the processor circuit 16 is caused to verify data of the enrollment token 33 (or the enrollment token 33 generally) prior to causing transmission of the enrollment token 33. For example, the processor circuit 16 may be caused to compare the at least one unique identifier 41 (e.g., a serial number, etc.) of the enrollment token 33 against an actual value of the at least one unique identifier (e.g., the actual serial number obtained from an invoice, purchase order, etc. of the target device 11). As another example, a size (e.g., number of bits) of the enrollment token 33 may be compared against an expected size of the enrollment token 33. Additionally, or alternatively, an enrollment token 33 may include signature data 44. As described elsewhere herein, verifying the enrollment token 33 may include verifying or authenticating the signature data 44. Verifying the signature data 44 may include verifying that the signature data 44 was added (or created) by an expected party such as the manufacturer of the target device.

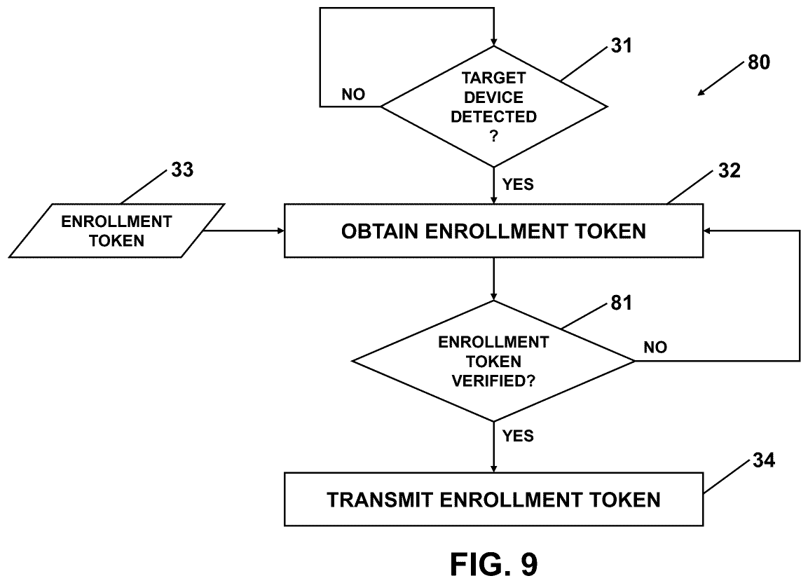

Referring to FIG. 9, program codes stored in the program-codes store 22 may include blocks of program codes shown generally at 80 that, when executed by the CPU 17, cause the processor circuit 16 to verify an obtained enrollment token 33 as part of enrolling a target device 11 with the security device management system 12. The blocks 80 are the same as the blocks 30 except that the blocks 80 also include block 81 between blocks 32 and 34. Block 81 includes program codes that, when executed by the CPU 17 cause the processor circuit 16 to verify or authenticate the enrollment token 33. If at block 81 the obtained enrollment token 33 is verified (or authenticated), the blocks 80 may continue at block 34. If, however, at block 81 the enrollment token 33 is not verified (or authenticated), the blocks 80 may return to block 32.

Any combination of two or more of blocks 61, 71 and 81 described herein may be combined with the blocks 30.

As described elsewhere herein, requesting an enrollment token 33 may include providing at least one unique identifier of a corresponding target device 11 such as a serial number. In some embodiments, the at least one unique identifier of the target device 11 is extracted from extraneous data. For example, extraneous data such as an invoice, purchase order, a bill of materials, a listing received from at least one entity associated with a remote system associated with the corresponding target device, a listing received from at least one entity associated with the security device management system, etc. for the target device 11 may include at least one unique identifier such as a serial number of the target device 11. The processor circuit 16 may be caused to scan or otherwise access the extraneous data and extract one or more unique identifiers of a target device 11 from the extraneous data. In some embodiments, the extraneous data comprises multiple items (e.g., multiple items such as invoices, purchase orders, bills of materials, listings received from at least one entity associated with a remote system associated with the corresponding target device, listings received from at least one entity associated with the security device management system, etc.) where each item of extraneous data corresponds to one or more of the target devices 11. In some such embodiments, the processor circuit 16 may be caused to scan each item of extraneous data to extract one or more unique identifiers corresponding to each of the target devices 11 represented by the extraneous data. In some embodiments, a single item of extraneous data (e.g., a single invoice, purchase order, bill of materials, listing received from at least one entity associated with a remote system associated with the corresponding target device, listing received from at least one entity associated with the security device management system, etc.) includes a plurality of unique identifiers where each of the unique identifiers of the plurality of unique identifiers corresponds to a different target device 11. In some such embodiments, the user computing apparatus may be caused to scan the item of extraneous data to extract at least M unique identifiers from the item of extraneous data where M corresponds to the number of target devices 11 represented in the extraneous data.

In some embodiments, the processor circuit 16 is caused to scan the extraneous data only until a desired unique identifier (or plurality of unique identifiers) is extracted.

In some embodiments, the processor circuit 16 is caused to scan the extraneous data only for unique identifiers corresponding to a subset of target devices 11.

In some embodiments, the processor circuit 16 is caused to run (or implement) an artificial intelligence model configured to extract one or more unique identifiers of the target devices 11 from extraneous data. For example, the artificial intelligence model may receive extraneous data as input and output one or more extracted unique identifiers corresponding to the target devices 11. In some embodiments, the artificial intelligence model includes a machine learning model. In some embodiments, the machine learning model includes a machine learning model trained to extract one or more unique identifiers of the target devices 11 from input extraneous data. In some embodiments, the machine learning model includes a natural language processing-based machine learning model. For example, a large language model (LLM) or similar natural language processing model may be provided with the various item(s) of extraneous data described hereinabove. The LLM may be provided with instructions to generate therefrom one or more enrollment tokens according to a predetermined format or structure. The enrollment tokens may then be used in accordance with any one or more of the embodiments described herein.

An installer or integrator may source and physically install the target device(s) 11 at a desired location. The installer or integrator may also initialize the target device(s) 11 as described herein. The target device(s) 11 may then be enrolled with the security device management system 12. The installer or integrator may, using computing apparatus 15, for example enroll the target device(s) 11 with the security device management system 12 as described herein. In some cases, the installer or integrator includes multiple individuals carrying out the required actions. Different individuals may be assigned different target devices 11 to enroll. In some cases, different individuals may be assigned different target devices 11 based on the manufacturers of the target devices 11 (e.g., a first individual may be assigned target devices 11 of a first manufacturer, a second individual may be assigned target devices 11 of a second manufacturer, a third individual may be assigned target devices 11 of a third manufacturer, etc.), based on the type of the target devices 11 (e.g., a first individual may be assigned target devices 11 of a first type (e.g., image capture devices), a second individual may be assigned target devices 11 of a second type (e.g., access control devices), a third individual may be assigned target devices 11 of a third type (e.g., intercom devices), etc.), based on the installation location of the target devices within the area being monitored, etc. In some cases, a person (or persons) who enrolls the target device(s) 11 is different than the installer or integrator who installed/initialized the target device(s) 11.

At some time, a current security device management system may need to be changed (e.g., as part of a renovation of the area, a change in provider of the security device management system, etc.). In some embodiments, the current security device management system may be configured to operate at least partially as a remote system 14 associated with the target device(s) 11 currently enrolled with the current security device management system and the new security device management system may be configured to operate as the security device management system 12. Enrollment tokens 33 may be obtained by the new security device management system (e.g., by requesting them from the target devices 11) and provided to, for example, the current security device management system as described herein. The current security device management system may then cause enrollment of the target device(s) 11 with the new security device management system as described herein. In some cases, the new security device management system obtains new enrollment tokens 33 by contacting the same remote system 14 or other authorized entity used initially by the current security device management system to obtain the previous enrollment tokens 33 used to initially effect enrollment of the target devices 11 therewith. Additionally, in some cases, the current security device management system may transmit an instruction to the currently enrolled target devices 11 to indicate that the target devices 11 are to be enrolled with the new security device management system. In response to such an instruction, the target devices 11 may set the aforementioned flag to indicate that the target devices 11 are unenrolled devices, which may in turn prompt the new security device management system, or agents associated therewith, to effect enrollment of the target devices with the new security device management system.

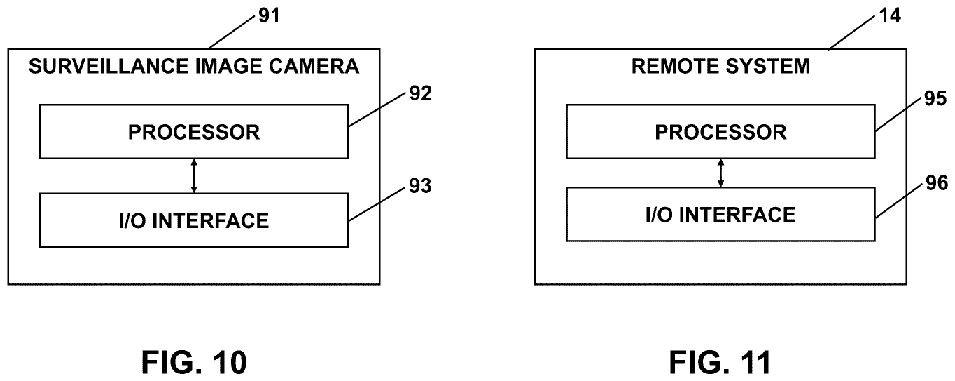

Referring to FIG. 10, an example surveillance image camera 91 is shown. A target device 11 may, for example, be the surveillance image camera 91 as described herein. The surveillance image camera 91 includes a processor 92 and an I/O interface 93 communicatively connected to the processor 92. The I/O interface 93 may, for example, communicatively connect the camera 91 to the communication network 13. The processor 92 may be configured to at least communicatively couple via a communication network (e.g., the communication network 13) the surveillance image capture device 91 to a remote system associated with the surveillance image capture device (e.g., remote system 14). Upon receiving at least one identifier of a security device management system (e.g., security device management system 12) from the remote system in response to the remote system receiving an enrollment token of the surveillance image capture device 91, the processor 92 may be configured to uncouple the surveillance image capture device 91 from the remote system and communicatively couple via the communication network the surveillance image capture device to the security device management system.

In some embodiments, the processor 92 is configured to at least cause transmission of an enrollment token (e.g., an enrollment token 33) to a user computing apparatus (e.g., the user computing apparatus 15) communicatively coupled to a security device management system (e.g., the security device management system 12). The transmitted enrollment token may comprise data uniquely identifying the surveillance image capture device 91 such as a serial number. In some embodiments, the processor 92 is configured to cause transmission of the enrollment token to the user computing apparatus upon receiving a request for the enrollment token from the user computing apparatus.

Referring to FIG. 11, an example remote system 14 comprising a processor 95 and an I/O interface 96 communicatively coupled to the processor 95 is shown. The I/O interface 96 may be configured to communicatively couple the remote system 14 to the communication network 13, the user computing apparatus 15, a target device 11 and/or the security device management system 12. The processor 95 may be configured to at least communicatively couple a target device 11 to the remote system 14 via a communication network (e.g., the communication network 13 or a different communication network). The processor 95 may also be configured to receive an enrollment token 33 corresponding to the target device 11. As described herein, the enrollment token 33 may comprise data uniquely identifying the target device 11 (e.g., the at least one unique identifier 41). In response to receiving the enrollment token 33, the processor 95 may be configured to effect enrollment of the target device 11 with the security device management system 12.

This disclosure further includes, but is not limited to, the following clauses, each of which may be combined with one or more other clauses or any other subject matter in this specification.

1. A method for execution by a user computing apparatus communicatively coupled to a communication network to effect enrollment of a first target device with a security device management system, the method comprising:
detecting that the first target device to be enrolled with the security device management system is connected to the communication network;
in response to the detecting, causing the user computing apparatus to obtain a first enrollment token corresponding to the first target device, the first enrollment token usable by the user computing apparatus to enroll the first target device with the security device management system, the first enrollment token comprising data uniquely identifying the first target device; and
causing transmission, by the user computing apparatus, of the first enrollment token to a first remote system associated with the first target device to effect enrollment of the first target device with the security device management system.

2. The method of clause 1, wherein causing transmission of the first enrollment token comprises causing the user computing apparatus to transmit the first enrollment token to the security device management system.

3. The method of clause 1, wherein causing the user computing apparatus to obtain the first enrollment token comprises the user computing apparatus receiving the first enrollment token from the first target device.

4. The method of clause 3, wherein the user computing apparatus receiving the first enrollment token comprises establishing a secure connection between the first target device and the user computing apparatus for the first target device to transmit the first enrollment token to the user computing apparatus.

5. The method of clause 1, wherein causing the user computing apparatus to obtain the first enrollment token comprises the user computing apparatus receiving the first enrollment token from the first remote system.

6. The method of clause 5, wherein the user computing apparatus receiving the first enrollment token comprises establishing a secure connection between the first remote system and the user computing apparatus for the first remote system to transmit the first enrollment token to the user computing apparatus.

7. The method of clause 1, further comprising in response to obtaining the first enrollment token, causing the user computing apparatus to verify the first enrollment token.

8. The method of clause 7, wherein causing the user computing apparatus to verify the first enrollment token comprises at least partially comparing the data of the first enrollment token against expected data of the first enrollment token.

9. The method of clause 7, wherein the first enrollment token comprises a signature and causing the user computing apparatus to verify the first enrollment token comprises causing the user computing apparatus to authenticate the signature of the first enrollment token.

10. The method of clause 1, wherein detecting that the first target device to be enrolled with the security device management system is connected to the communication network comprises causing the user computing apparatus to perform network discovery detecting one or more devices connected to the communication network.

11. The method of clause 10, wherein the network discovery is performed periodically.

12. The method of clause 10, wherein the network discovery is initiated by a user of the user computing apparatus.

13. The method of clause 10, wherein the network discovery is initiated by the first target device being communicatively coupled to the communication network.

14. The method of clause 10, wherein the network discovery comprises causing the user computing apparatus to compare a newly detected network device identifier against one or more known network device identifiers associated with one or more devices already enrolled with the security device management system.

15. The method of clause 10, wherein the network discovery comprises causing the user computing apparatus to detect one or more devices comprising at least one flag set to indicate the corresponding device is newly connected to the communication network.

16. The method of clause 1, further comprising in response to the detecting, causing the user computing apparatus to verify that the first target device is to be enrolled with the security device management system prior to obtaining the first enrollment token.

17. The method of clause 1, further comprising in response to obtaining the first enrollment token corresponding to the first target device, causing the user computing apparatus to obtain a second enrollment token corresponding to a second target device to be enrolled with the security device management system and to cause transmission of the second enrollment token to a second remote system associated with the second target device to effect enrollment of the second target device.

18. The method of clause 17, further comprising in response to obtaining the second enrollment token, causing the user computing apparatus to verify the second enrollment token.

19. The method of clause 17, wherein the first remote system and the second remote system are the same.

20. The method of clause 17, further comprising upon effecting enrollment of the second target device with the security device management system, causing the user computing apparatus to determine whether a third target device is to be enrolled with the security device management system.

21. The method of clause 1, wherein the first target device is a surveillance image capture device, an intercom device or an access control device.

22. The method of clause 1, wherein the first target device is initially communicatively coupled to the first remote system by the communication network.

23. The method of clause 1, wherein causing the user computing apparatus to obtain the first enrollment token corresponding to the first target device comprises causing the user computing apparatus to transmit a unique identifier of the first target device in exchange for the first enrollment token.

24. A method for execution by a user computing apparatus communicatively coupled to a communication network to effect enrollment of a plurality of target devices with a security device management system, the method comprising:
detecting that the plurality of target devices are connected to the communication network;
causing the user computing apparatus to obtain a plurality of enrollment tokens, each of the enrollment tokens corresponding to a corresponding target device of the plurality of the target devices, each of the enrollment tokens usable by the user computing apparatus to enroll the corresponding target device with the security device management system, each of the enrollment tokens comprising data uniquely identifying the corresponding target device; and
causing transmission, by the user computing apparatus, of each enrollment token of the plurality of enrollment tokens to a remote system associated with the corresponding target device to effect enrollment of the corresponding target device with the security device management system.

25. The method of clause 24, wherein causing the user computing apparatus to obtain a plurality of enrollment tokens comprises causing the user computing apparatus to generate the plurality of enrollment tokens.

26. The method of clause 25, wherein each of the plurality of enrollment tokens is generated from data received by the user computing apparatus from the remote system associated with the corresponding target device.

27. The method of clause 24, wherein each target device of the plurality of target devices is a surveillance image capture device, an intercom device or an access control device.

28. The method of clause 24, wherein the detecting that the plurality of target devices are connected to the communication network is performed subsequent to the causing transmission of each of the enrollment tokens.

29. A method for execution by a user computing apparatus communicatively coupled to a communication network to effect enrollment of a target device with a security device management system, the method comprising:
causing the user computing apparatus to obtain an enrollment token corresponding to the target device, the enrollment token usable by the user computing apparatus to enroll the target device with the security device management system, the enrollment token comprising data uniquely identifying the target device; and
causing transmission, by the user computing apparatus, of the enrollment token to a remote system associated with the target device to effect enrollment of the target device with the security device management system.

30. The method of clause 29, further comprising subsequent to the causing transmission of the enrollment token detecting that the target device is connected to the communication network.

31. A surveillance image capture device comprising a processor configured to:
communicatively couple the surveillance image capture device to a remote system associated with the surveillance image capture device; and
upon receiving at least one identifier of a security device management system from the remote system in response to the remote system receiving an enrollment token of the target device, uncouple the surveillance image capture device from the remote system and enroll the surveillance image capture device with the security device management system.

32. A surveillance image capture device comprising a processor configured to cause transmission of an enrollment token to a user computing apparatus communicatively coupled to a security device management system, the enrollment token comprising data uniquely identifying the surveillance image capture device.

33. The surveillance image capture device of clause 32, wherein the processor is configured to cause transmission of the enrollment token to the user computing apparatus upon receiving a request for the enrollment token from the user computing apparatus.

34. A remote system associated with a target device, the remote system comprising a processor configured to:
communicatively couple the target device to the remote system;
receive an enrollment token of the target device, the enrollment token comprising data uniquely identifying the target device; and
in response to receiving the enrollment token, effect enrollment of the target device with a security device management system.

35. A computer program product comprising a computer readable memory storing computer executable instructions thereon that when executed by a computer perform the method of any one of clauses 1 to 28.

It will be appreciated by those skilled in the art that changes could be made to the various aspects of the subject application described above without departing from the inventive concept thereof. It is to be understood, therefore, that this subject application is not limited to the particular aspects disclosed, but it is intended to cover modifications as defined by the appended claims. Also, it should be appreciated that not all features are required in all embodiments.

When introducing elements of the present invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed element.

1. A method for execution by a user computing apparatus communicatively coupled to a communication network to effect enrollment of a first target device with a security device management system, the method comprising:
detecting that the first target device to be enrolled with the security device management system is connected to the communication network;
in response to the detecting, causing the user computing apparatus to obtain a first enrollment token corresponding to the first target device, the first enrollment token usable by the user computing apparatus to enroll the first target device with the security device management system, the first enrollment token comprising data uniquely identifying the first target device; and
causing transmission, by the user computing apparatus, of the first enrollment token to a first remote system associated with the first target device to effect enrollment of the first target device with the security device management system.

2. The method of claim 1, wherein causing transmission of the first enrollment token comprises causing the user computing apparatus to transmit the first enrollment token to the security device management system.

3. The method of claim 1, wherein causing the user computing apparatus to obtain the first enrollment token comprises the user computing apparatus receiving the first enrollment token from the first target device.

4. The method of claim 3, wherein the user computing apparatus receiving the first enrollment token comprises establishing a secure connection between the first target device and the user computing apparatus for the first target device to transmit the first enrollment token to the user computing apparatus.

5. The method of claim 1, wherein causing the user computing apparatus to obtain the first enrollment token comprises the user computing apparatus receiving the first enrollment token from the first remote system.

6. The method of claim 5, wherein the user computing apparatus receiving the first enrollment token comprises establishing a secure connection between the first remote system and the user computing apparatus for the first remote system to transmit the first enrollment token to the user computing apparatus.

7. The method of claim 1, further comprising in response to obtaining the first enrollment token, causing the user computing apparatus to verify the first enrollment token.

8. The method of claim 7, wherein causing the user computing apparatus to verify the first enrollment token comprises at least partially comparing the data of the first enrollment token against expected data of the first enrollment token.

9. The method of claim 7, wherein the first enrollment token comprises a signature and causing the user computing apparatus to verify the first enrollment token comprises causing the user computing apparatus to authenticate the signature of the first enrollment token.

10. The method of claim 1, wherein detecting that the first target device to be enrolled with the security device management system is connected to the communication network comprises causing the user computing apparatus to perform network discovery detecting one or more devices connected to the communication network.

11. The method of claim 10, wherein the network discovery is initiated by the first target device being communicatively coupled to the communication network.

12. The method of claim 10, wherein the network discovery comprises causing the user computing apparatus to compare a newly detected network device identifier against one or more known network device identifiers associated with one or more devices already enrolled with the security device management system.

13. The method of claim 10, wherein the network discovery comprises causing the user computing apparatus to detect one or more devices comprising at least one flag set to indicate the corresponding device is newly connected to the communication network.

14. The method of claim 1, further comprising in response to the detecting, causing the user computing apparatus to verify that the first target device is to be enrolled with the security device management system prior to obtaining the first enrollment token.

15. The method of claim 1, further comprising in response to obtaining the first enrollment token corresponding to the first target device, causing the user computing apparatus to obtain a second enrollment token corresponding to a second target device to be enrolled with the security device management system and to cause transmission of the second enrollment token to a second remote system associated with the second target device to effect enrollment of the second target device.

16. The method of claim 1, wherein causing the user computing apparatus to obtain the first enrollment token corresponding to the first target device comprises causing the user computing apparatus to transmit a unique identifier of the first target device in exchange for the first enrollment token.

17. A method for execution by a user computing apparatus communicatively coupled to a communication network to effect enrollment of a plurality of target devices with a security device management system, the method comprising:
detecting that the plurality of target devices are connected to the communication network;
causing the user computing apparatus to obtain a plurality of enrollment tokens, each of the enrollment tokens corresponding to a corresponding target device of the plurality of the target devices, each of the enrollment tokens usable by the user computing apparatus to enroll the corresponding target device with the security device management system, each of the enrollment tokens comprising data uniquely identifying the corresponding target device; and
causing transmission, by the user computing apparatus, of each enrollment token of the plurality of enrollment tokens to a remote system associated with the corresponding target device to effect enrollment of the corresponding target device with the security device management system.

18. The method of claim 17, wherein causing the user computing apparatus to obtain a plurality of enrollment tokens comprises causing the user computing apparatus to generate the plurality of enrollment tokens.

19. The method of claim 18, wherein each of the plurality of enrollment tokens is generated from data received by the user computing apparatus from the remote system associated with the corresponding target device.

20. The method of claim 17, wherein the detecting that the plurality of target devices are connected to the communication network is performed subsequent to the causing transmission of each of the enrollment tokens.

21. A computer program product comprising a computer readable memory storing computer executable instructions thereon that when executed by a computer perform the method of claim 1.

22. A computer program product comprising a computer readable memory storing computer executable instructions thereon that when executed by a computer perform the method of claim 17.
